(19) United States
(12) Patent Application Publication
(10) Pub. No.: US 2015/0028941 A1
(43) Pub. Date: Jan. 29, 2015

(54) CONTROLLED POWER SWITCH CHAIN SEQUENCING FOR BOTH POWER UP AND POWER DOWN OF A POWER DOMAIN

(71) Applicant: Texas Instruments Incorporated, Dallas, TX (US)

(72) Inventors: Jose L. Flores, Richardson, TX (US); Sureshkumar Govendaraj, Irving, TX (US)

(21) Appl. No.: 14/445,617

(22) Filed: Jul. 29, 2014

Related U.S. Application Data
(60) Provisional application No. 61/859,378, filed on Jul. 29, 2013.

(51) Int. Cl. H02M 3/158

(52) U.S. Cl. CPC H02M 3/158
USPC 327/538

(57) ABSTRACT

This invention makes the change in current drawn from the power grid in an integrated circuit gradual by sequencing the power switch chains differently for both power up and power down. During power up, this invention establishes a reasonable connection with the power grid through a series of weak power switches and then starts turning on the strong power switches. During power down, this invention reverses the process. Strong switches are all turned off before turning off the weak switches.

### CLAIM OF PRIORITY

This application claims priority under 35 U.S.C. 119(e)(1) to U.S. Provisional Application No. 61/859,378 filed Jul. 29, 2013.

### TECHNICAL FIELD OF THE INVENTION

The technical field of this invention is power supply control in integrated circuits.

### BACKGROUND OF THE INVENTION

The current surge during power up or power down of a power domain on a large integrated circuit can cause functional failures to the device and/or cause reliability issues in the transistors. The prior art generally considered this a problem only during power up. Power supply instability is an issue during power down. When the current drawn suddenly drops oscillations in the supply may occur producing undershoots and overshoots. This behavior is observed in prior designs and is expected to get worse with future larger designs.

### SUMMARY OF THE INVENTION

This invention makes the change in current drawn from the power grid gradual by sequencing the power switch chains differently for both power up and power down. During power up, this invention establishes a reasonable connection with the power grid through a series of weak power switches and then starts turning on the strong power switches. Thus the current load of a power domain is ramped up. During power down, this invention reverses the process. Strong switches are all turned off before turning off the weak switches.

The prior art comprehends only the power up case but this invention handles both power up and power down scenarios.

### BRIEF DESCRIPTION OF THE DRAWINGS

These and other aspects of this invention are illustrated in the drawings, in which:

FIG. 1 illustrates the power control system of this invention;

FIG. 2 illustrates the prior art manner of implementing power switches as chains of switching transistors triggered in a predetermined sequence with a predetermined delay;

FIG. 3 illustrates the respective power switch drive signals for power up according to this invention;

FIG. 4 illustrates the respective power switch drive signals for power down according to this invention; and

FIG. 5 illustrates an example state machine states for practicing this invention.

### DETAILED DESCRIPTION OF PREFERRED EMBODIMENTS

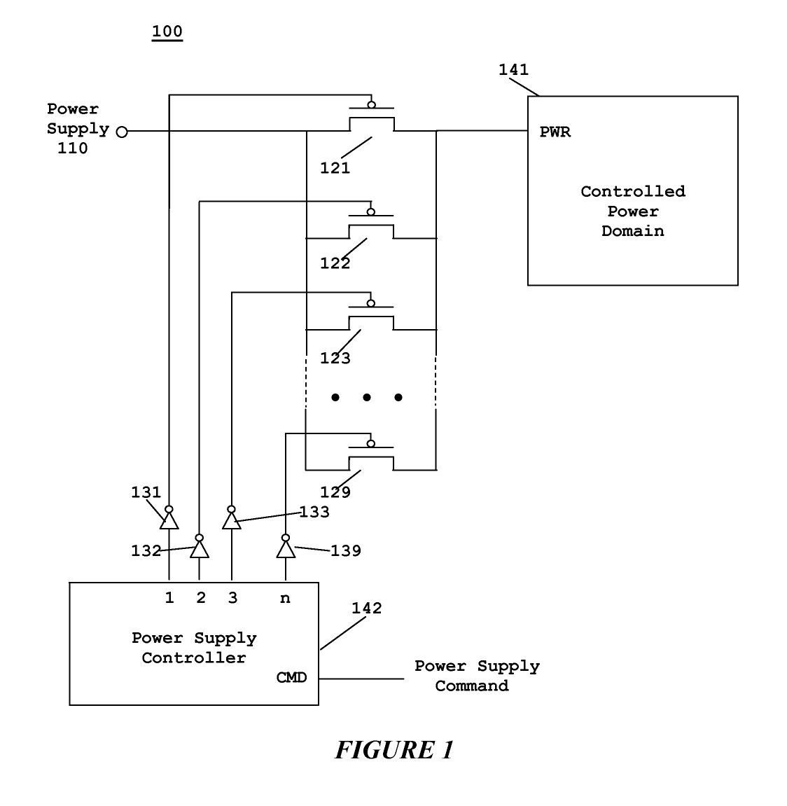

FIG. 1 illustrates the power control system 100 used in this invention. Power supply 110 supplies power for various power domains in the integrated circuit including power domain 141. A set of power switches 121, 122, 123 . . . 129 couples power supply 110 to the power (PWR) input of power domain 141. Power supply controller 142 controls the conductive/non-conductive state of power switches 121, 122, 123 . . . 129 via a corresponding inverter 131, 132, 133 . . . 139. The input of each of power switches 121, 122, 123 . . .

129 is supplied with an individual signal from power supply controller 142. This invention controls the sequence of power switch activations.

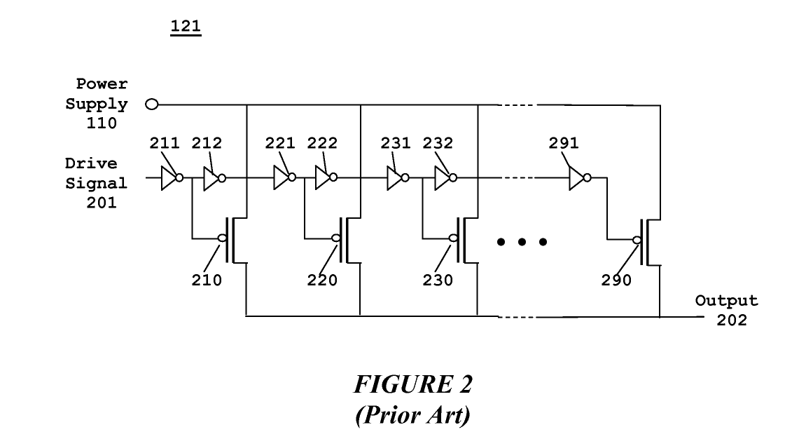

FIG. 2 illustrates a prior art implementation of power switches 121, 122, 123 . . . 129 of FIG. 1. In the prior art these power switches are implemented by a serially triggered chain of transistors. In FIG. 2, Power Supply 110 connects to one terminal of the source-drain path of transistors 210, 220, 230 . . . 290. The other source-drain terminal of each transistor 210, 220, 230 . . . 290 connects to output 202 which connects to the power supply input of the controlled power domain 141. When driven to conduct each transistor 210, 220, 230 . . . 290 supplies power from power supply 110 to controlled power domain 141.

The transistors 210, 220, 230 . . . 290 are sequentially energized via an inverter chain. Drive signal 201 from a corresponding output of power supply controller 142 is input to inverter 211. The output of inverter 211 is connected to the gate of transistor 210 and to the input of inverter 212. The output of inverter 212 is connected to the input of inverter 221. The output of inverter 221 is connected to the gate of transistor 220 and to the input of inverter 222. The output of inverter 222 is connected to the input of inverter 231. The output of inverter 231 is connected to the gate of transistor 230 and to the input of inverter 232. The output of inverter 212 is connected to the input of a next inverter. This inverter chain continues to inverter 291. The output of inverter 291 is connected to the gate of transistor 290.

An input from drive signal 201 causes inverter 211 to switch transistor 210 ON. Inverter 211 also switches inverter 212. This input caused inverter 212 to switch inverter 221. Inverter 221 to switch transistor 220 ON. Each inverter in the chain causes a delay from its input before its output switches. This causes a propagation delay before the next transistor switches ON. Thus switches 210, 220, 230 . . . 290 switch ON sequentially as the input travels the inverter chain. The delay of each inverter in the chain depends upon the size of the transistors used in the inverter (bigger transistors switch faster) and the load on the output. Larger transistors 210, 220, 230 . . . 290 have larger gate capacitance requiring the corresponding driver to move more charge to turn the transistor ON. Thus larger transistors 210, 220, 230 . . . 290 cause the inverter chain to propagate slower than smaller transistors. Thus transistors 210, 220, 230 . . . 290 turn ON sequentially. When turning OFF a similar delay occurs in the inverter chain causing a corresponding sequential action in turning OFF transistors 210, 220, 230 . . . 290. This causes transistors 210, 220, 230 . . . 290 to turn OFF sequentially.

In accordance with this invention the power switches 121, 122, 123 . . . 129 are not identical. Instead, power switches 121, 122, 123 . . . 129 are constructed from a variety of strengths. A strong switch can carry a large current and produces a small IR voltage drop. A weak switch carries a smaller current and provides a larger IR voltage drop. The strength of these switches is controlled by the width of the source-drain channel of the corresponding transistors 211, 212, 213 . . . 219. In general a wider source-drain channel produces a stronger transistor than a narrow source-drain channel.

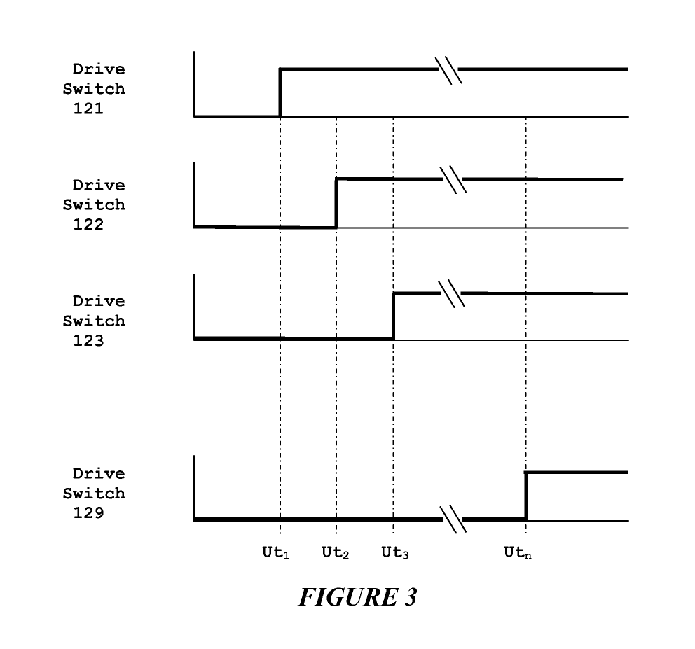

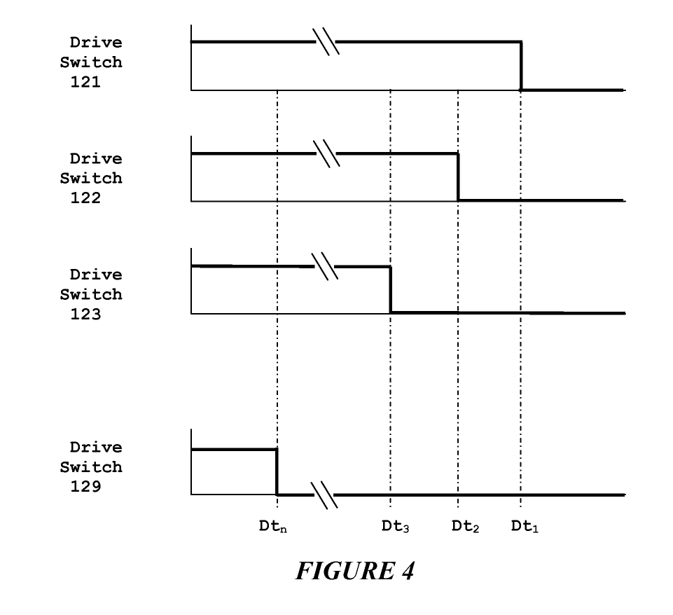

This example embodiment shows p-channel metal oxide semiconductor (PMOS) transistors controlling conduction of the voltage supply (V_{dd}) to the power domain. Those skilled in the art would realize this invention could be practiced using n-channel metal oxide semiconductor (NMOS) transistors to control conduction of ground (Vₛₛ) to the power domain. Such a change would require inversion of the drive voltages (FIGS. 3 and 4) to control the NMOS transistors. Other aspects of such an NMOS circuit would operate as described here.

In accordance with the preferred embodiment of this invention power switches 121, 122, 123 . . . 129 are arranged in strength from weakest transistor to strongest transistor. During power up, weak switches are turned ON first, followed by strong switches. During power down, strong switches are turned OFF first, followed by weak switches.

FIG. 3 illustrates a drive sequence for power up in accordance with this invention. FIG. 3 illustrates separate drive voltage for switches 121, 122, 123 and 129. Before time Ut₁ all the switches are driven by a low voltage and they are all OFF and nonconductive. At time Ut₁ a power up begins by changing the drive to power switch 121 to turn ON. This provide initial power to power domain 141. At time Ut₂ the power up changes the drive to power switch 122 to turn ON. Power switch 121 remains ON. This increases the current available to power domain 141. At time Ut₃ power switch 123 turns ON. The power up sequence continues to power more and more power switches having greater and greater strength. At time Utₙ power switch 129 is turned ON. Power switch 129 is the last and strongest power switch. At this time power domain 141 is fully powered because all power switches 121, 122, 123 . . . 129 are ON.

FIG. 4 illustrates a drive sequence for power down in accordance with this invention. FIG. 4 illustrates separate drive voltage for switches 121, 122, 123 and 129. Before time Dtₙ all the switches are driven by a high voltage and they are all ON. At time Dtₙ a power down begins by changing the drive to power switch 129 to turn OFF. According to the preferred embodiment power switch 129 is the strongest switch. At time Dt₃ the power up changes the drive to power switch 123 to turn OFF. Power switch 129 remains OFF. This further reduces the current available to power domain 141. At time Dt₂ power switch 122 turns OFF. The power up sequence continues to power fewer and fewer power switches. At time Dt₁ power switch 121 is turned OFF. Power switch 121 is the last and weakest power switch. At this time power domain 141 is completely OFF because all power switches 121, 122, 123 . . . 129 are OFF.

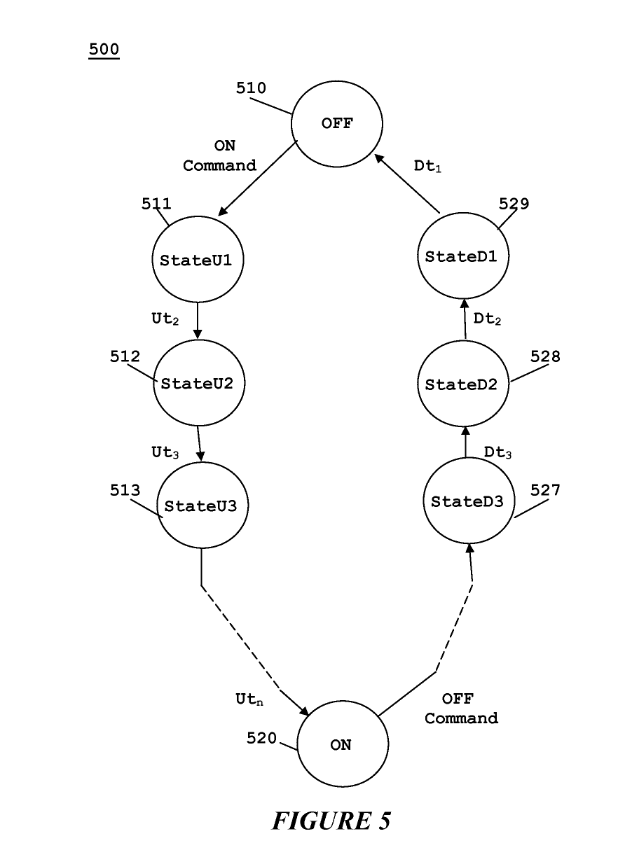

FIG. 5 illustrates the states of a finite state machine 500 constructed to control the power up sequence illustrated in FIG. 2 and the power down sequence illustrated in FIG. 3. State 510 is a fully OFF state. All power switches are controlled OFF in this state. Receipt of an external ON command causes state machine 500 to advance to state 511. In state 511 power switch 121 is ON. State machine 500 advances to state 512 upon reaching time Ut₂ following the ON command. In state 512 both power switches 121 and 122 are ON. State machine 500 advances to state 513 upon reaching time Utₐ following the ON command. In state 512 power switches 121, 122 and 123 are ON. State machine 500 continues advancing states and powering more power switched until reaching time Utₙ following the ON command. State machine 500 then enters ON state 520. In ON state 520 all power switches 121, 122, 123 . . . 129 are ON.

State machine 500 remains in ON state 520 until receipt of an external OFF command. On receipt of the OFF command state machine 500 advances toward state 510 periodically turning OFF power switches starting with the strongest. State machine 500 advances to state 527. In state 527 power switches 121, 122 and 123 are ON and all stronger power switches are OFF. State machine 500 advances to state 528 upon reaching time Dt₃ following the OFF command. In state 528 power switches 121 and 122 are ON and power switches 123 . . . 129 are OFF. State machine 500 advances to state 529 upon reaching time Dt₂ following the OFF command. In state 529 power switch 121 is ON and power switches 122, 123 . . . 129 are OFF. State machine 500 advances to state 510 upon reaching time Dt₂ following the OFF command. As described above, in state 510 all power switches 121, 122, 123 . . . 129 are OFF.

State machine 500 may be implemented by special purpose hardware or by a suitably programmed microcomputer. If the integrated circuit including power control system 100 includes a programmable central processing unit, some portion of the computing capacity could be devoted to this power supply control.

This invention provides controlled shutdown of power switch chains and hence avoids functional failure or damage to the transistors. Controlling the power down of a power domain, ensures proper functionality of other power domains that share the power grid. This permits proper functioning of dynamic power management. The main differentiation of this invention over the prior art is making the transient change in current consumption slowly not only during power-up but also during power down.

What is claimed is:

1. A power control system for a power domain on an integrated circuit comprising:
a power supply;
a plurality of power switches, each having a first terminal connected to said power supply, a second terminal connected to a power supply input of the power domain and an input for control of conduction between said first terminal and said second terminal; and
a power supply controller having a plurality of outputs, each output connected to said input of a corresponding power switch, said power supply controller operable to
power up the power domain by supplying signals on said outputs to inputs of corresponding power switches to sequentially conduct via more and more power switches until all power switches conduct, and
power down the power domain by supplying signals on said outputs to inputs of corresponding power switches to sequentially conduct via fewer and fewer power switches until no power switch conducts.

2. The power supply control system of claim 1, wherein:
said power supply switches have differing conduction strengths; and
said power supply controller is operable on power up to sequentially conduct power switches beginning with weakest power supply switches and ending with strongest power supply switches.

3. The power supply control system of claim 1, wherein:
said power supply switches have differing conduction strengths; and
said power supply controller is operable on power down to sequentially disconduct power switches beginning with strongest power supply switches and ending with weakest power supply switches.

4. A method for supplying power to a power domain on an integrated circuit comprising the steps of:
powering up the power domain by sequentially conducting more and more current until a maximum current is reached; and
powering down the power domain by sequentially conducting via less and less current until no current is conducted.
